(19) United States
(12) Patent Application Publication
(10) Pub. No.: US 2012/0046482 A1
(43) Pub. Date: Feb. 23, 2012

(54) METHOD FOR SYNTHESIZING GOLD NANOPARTICLES

(75) Inventors: JIAN-WEI GUO, Beijing (CN); XIANG-MING HE, Beijing (CN); CHENG WANG, Beijing (CN); ZHI-XIANG LIU, Beijing (CN); WEI-HUA PU, Beijing (CN); JIAN-JUN LI, Beijing (CN)

(73) Assignees: HON HAI PRECISION INDUSTRY CO., LTD., Tu-Cheng (TW); TSINGHUA UNIVERSITY, Beijing (CN)

(21) Appl. No.: 12/949,992

(22) Filed: Nov. 19, 2010

(30) Foreign Application Priority Data
Aug. 23, 2010 (CN) 201010259928.3

(51) Int. Cl. C07F 1/12

(52) U.S. Cl. 556/114; 977/775; 977/755; 977/762

(57) ABSTRACT

The present disclosure relates to a method for synthesizing gold nanoparticles. In the method, a gold ion containing solution and a carboxylic acid including at least two carboxyl groups are provided. The gold ion containing solution and the carboxylic acid are mixed to form a mixture. The mixture is reacted at a reaction temperature of about 20° C. to about 60° C.

### CROSS-REFERENCE TO RELATED APPLICATIONS

This application claims all benefits accruing under 35 U.S.C. §119 from China Patent Application No. 201010259928.3, filed on Aug. 23, 2010 in the China Intellectual Property Office, the contents of which are hereby incorporated by reference.

### BACKGROUND

1. Technical Field

The present disclosure relates to methods for synthesizing metal particles and, particularly, to methods for synthesizing gold nanoparticles.

2. Description of Related Art

Gold nanoparticles have unique physical and chemical properties such as their small size effect, surface effect, quantum size effect, and quantum tunnel effect. Gold nanoparticles are widely used in various fields such as catalysts, chemical sensors, biosensors, optoelectronic devices, optical devices, nano-devices, and surface enhanced Raman scattering (SERS).

Properties of the gold nanoparticles depend on their size and shape. Therefore, there is a challenge to control the size and shape of the gold nanoparticles, thereby controlling the properties thereof.

The gold nanoparticles have been produced by using a method called as “Turkevich method” (“The Formation of Colloidal Gold”, J Turkevich, P. C. Stevenson, J Hillier, The Journal of Physical Chemistry, Vol. 57 (1953) 670-673). The Turkevich method uses a redox process to produce the gold particles by adding a sodium citrate into a boiling chloroauric acid solution. The shape of the gold nanoparticles produced by this method is substantially spherical.

In a US patent application publication number US20060021468, a stabilizer such as polyvinylpyrrolidone (PVP) is added to the heated solution during the redox process between the chloroauric acid solution and the sodium citrate, to achieve plate shaped gold nanoparticles. However, adding the stabilizer makes the method more complicated.

What is needed, therefore, is to provide a novel, simpler method for synthesizing gold particles by which the morphology of the gold nanoparticles is conveniently controlled.

### BRIEF DESCRIPTION OF THE DRAWING

Many aspects of the present disclosure can be better understood with reference to the following drawings. The components in the drawings are not necessarily to scale, the emphasis instead being placed upon clearly illustrating the principles of the present embodiments.

FIGS. 1A-1D are photos showing transmission electron microscope (TEM) images of gold nanoplates synthesized by an embodiment of a method for synthesizing gold nanoparticles.

FIGS. 2A-2D are photos showing TEM images of gold nanonetworks synthesized by another embodiment of the method for synthesizing gold nanoparticles.

FIGS. 3A-3D are photos showing TEM images of gold nanochains synthesized by yet another embodiment of the method for synthesizing gold nanoparticles.

### DETAILED DESCRIPTION

The disclosure is illustrated by way of example and not by way of limitation in the figures of the accompanying drawings in which like references indicate similar elements. It should be noted that references to “another,” “an,” or “one” embodiment in this disclosure are not necessarily to the same embodiment, and such references mean at least one.

One embodiment of a method for synthesizing gold nanoparticles includes:

S1, providing a gold ion containing solution and a carboxylic acid including at least two carboxyl groups;

S2, mixing the gold ion containing solution and the carboxylic acid to form a mixture; and

S3, reacting the mixture at a reaction temperature of about 20° C. to about 60° C. wherein the carboxylic acid is used as both stabilizing agent and reducing agent during the reaction, to achieve a gold nanoparticle colloidal solution.

In step S1, the gold ion containing solution includes a solvent and a gold source dissolved in the solvent. The solvent can be water, ethanol, acetone, chloroform, or a mixture thereof. The gold source is a gold compound, such as chloroauric acid (HAuCl₄), gold trichloride (AuCl₃), and gold potassium chloride (KAuCl₄). In the method, the carboxylic acid is used as both the stabilizing agent and the reducing agent at the relatively low reaction temperature (e.g., <60° C.), wherein the stabilizing effect of the carboxylic acid is relatively stronger than the reducing effect of the carboxylic acid. Therefore, the reaction in step S3 is relatively slow, and the gold nanoparticles with desired morphology can be stabilized. The carboxylic acid includes at least two carboxyl groups, and can be citric acid (C₆H₈O₇), oxalic acid (C₂H₂O₄), malonic acid (C₃H₄O₄), and/or butane diacid (C₄H₆O₄).

In step S2, the gold ion containing solution and the carboxylic acid can be mixed together or both added to another solvent to form the mixture. The mixture can be stirred to evenly mix the gold ion containing solution and the carboxylic acid together. The molar ratio of the gold ions in the gold ion containing solution to the carboxylic acid can be in a range from about 10:1 to about 1:10. The morphology of the gold nanoparticles changes with the molar ratio of the gold ions to the carboxylic acid. Therefore, the method can further include a step of controlling the morphology of the gold nanoparticles by adjusting the molar ratio of the gold ions to the carboxylic acid.

In step S3, the reacting step is performed at a relatively low reaction temperature, and thus the morphology of the gold nanoparticles can be controlled easily. In one embodiment, the reaction temperature is in a range from about 30° C. to about 50° C. The mixture can be reacted in a water bath container or sand bath container. The heating step can be processed by previously heating the gold ion containing solution and/or the carboxylic acid to the reaction temperature before the step S2 of mixing. The achieved gold nanoparticles can be at least one of gold nanoplates, gold nanonetworks, gold nanochains, and monodispersed gold nanograins. The gold nanoplate has a planar shape. The gold nanonetwork and the nanochain both include a plurality of gold nanograins connected with each other by carboxyl groups. The gold nanograins in the gold nanonetwork are connected together to form a network. The gold nanograins in the gold nanochains are connected in succession to form a line.

The morphology of the gold nanoparticles changes with the reaction time of step S3. Therefore, the method can further include a step of stopping the reaction of step S3 by rapidly cooling the mixture, thereby controlling the reaction time of step S3, and achieving gold nanoparticles with different morphology. In one embodiment, samples of the mixture are taken from the mixture at several certain intervals of time and cooled by immersing the samples in a cold water (e.g., <5° C.). The reaction time of step S3 can be controlled in a range from about 15 minutes to about 24 hours to achieve different morphologies of gold nanoparticles.

The method can further include an optional step of adjusting the pH value of the mixture to further control the morphology of the gold nanoparticles. The pH value of the mixture is another factor that affects the morphology of the gold nanoparticles. The pH value of the mixture can be adjusted in a range from about 2 to about 12.7. The greater the pH value, the stronger the monodispersity of the gold nanoparticles. The step of adjusting pH value may be processed at a beginning of the reaction of step S3, and the desired pH value can be kept to the end of the reaction. The pH value can be adjusted by adding acid, alkali, acid salt, or basic salt to the mixture. In one embodiment, the pH value is adjusted by adding a hydrochloric acid or a sodium hydroxide to the mixture.

More specifically, the method can further include an optional step of adjusting the pH value to about 2-4.4 to form gold nanoplates. The gold nanoplates are planar structures with a shape of a triangular plate, a rectangular plate, a truncated triangular plate, a hexagon plate, or other polygon plates. The truncated triangular plate and hexagon plate are both based on the triangular plate. A length of the sides of the gold nanoplates can be in a range from about 20 nanometers to about 100 nanometers. A thickness of the gold nanoplates can be in a range from about 5 nanometers to about 8 nanometers.

The method can further include an optional step of adjusting the pH value to about 4.5-7.8 to form gold nanonetworks. The gold nanonetworks are composed by a plurality of gold nanochains connected with each other by the carboxyl groups. The gold nanochains are composed of a plurality of gold nanograins connected with each other in line by the carboxyl groups.

The method can further include an optional step of adjusting the pH value to about 7.9-12.7 to form the gold nanochains.

The method can further include an optional step of adding another supplemental reducing agent to the mixture to form monodispersed gold nanograins. A molar ratio of the supplemental reducing agent to the gold ions in the mixture can be in a range from about 3:1 to about 7:1. The morphology of the gold nanoparticles can be related to the amount of the supplemental reducing agent and the reducibility of the supplemental reducing agent. The more the supplemental reducing agent and the stronger the reducibility of the supplemental reducing agent, the more monodispersed gold nanograins can be achieved. The supplemental reducing agent can be at least one of sodium borohydride (NaBH₄), formaldehyde (CH₂O), and ascorbic acid. A diameter of the gold nanograins can be in a range from about 10 nanometers to about 100 nanometers.

The method is processed at a relatively low reaction temperature and the self-assembly rate of the gold nanoparticles is relatively slow. Therefore, the morphology of the gold nanoparticles can be precisely controlled and the gold nanoparticles with desired morphology can be easily achieved. The reaction temperature is relatively low, and thus the gold nanoparticles with desired morphology can be achieved by simply adjusting the pH value of the mixture before or at the beginning of the reaction, without any additional stabilizing agent. The gold nanoparticles with desired morphology can be stabilized for a relatively long time (e.g., at least one week) by simply stopping the reaction. Additionally, the method does not need any other chemical reagent except the gold source, the carboxylic acid, and the solvent. Therefore, the method is simple and has a low cost.

### EXAMPLES

The gold nanoparticles with different morphologies are synthesized by using a HAuCl₄ water solution as the gold ion containing solution and a C₆H₈O₇ as the carboxylic acid in the following examples.

### Example 1

### Synthesis of the Gold Nanoplates

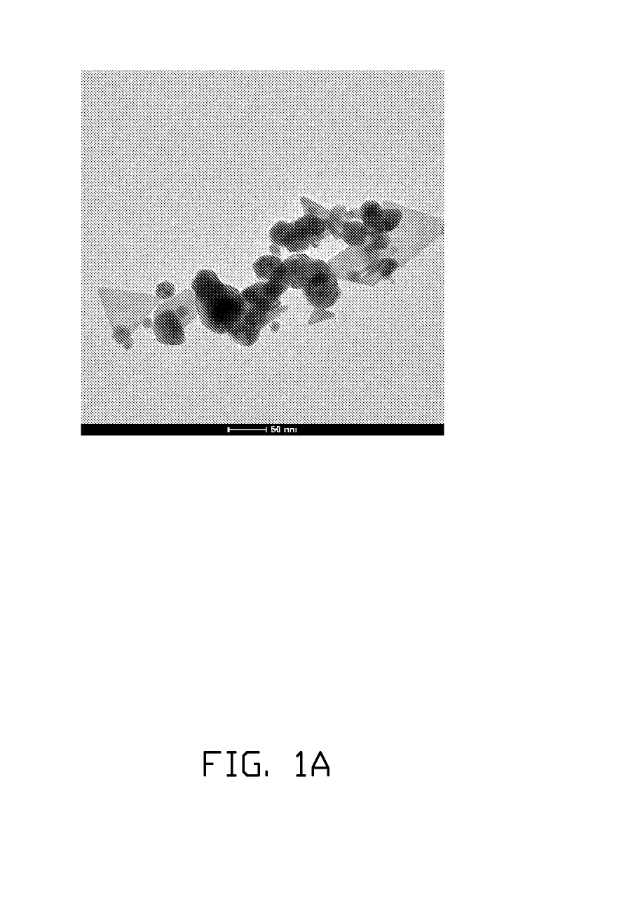

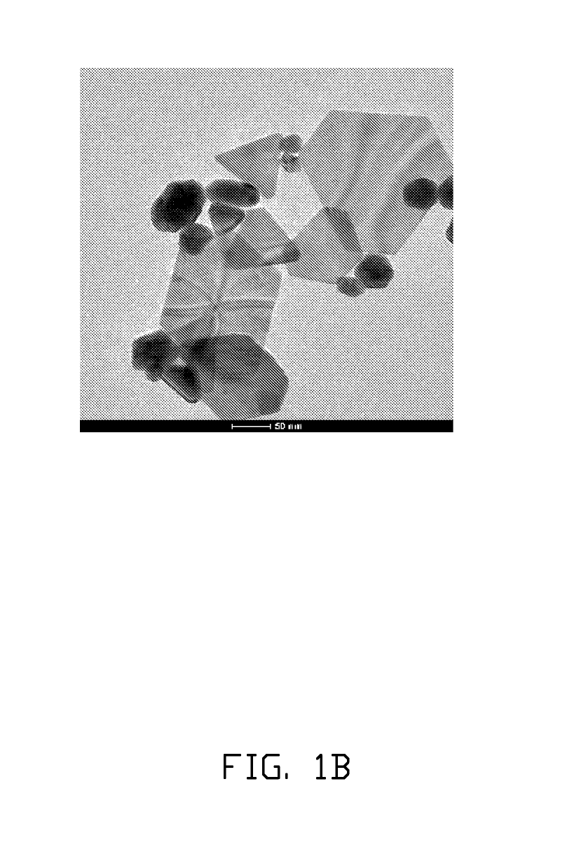

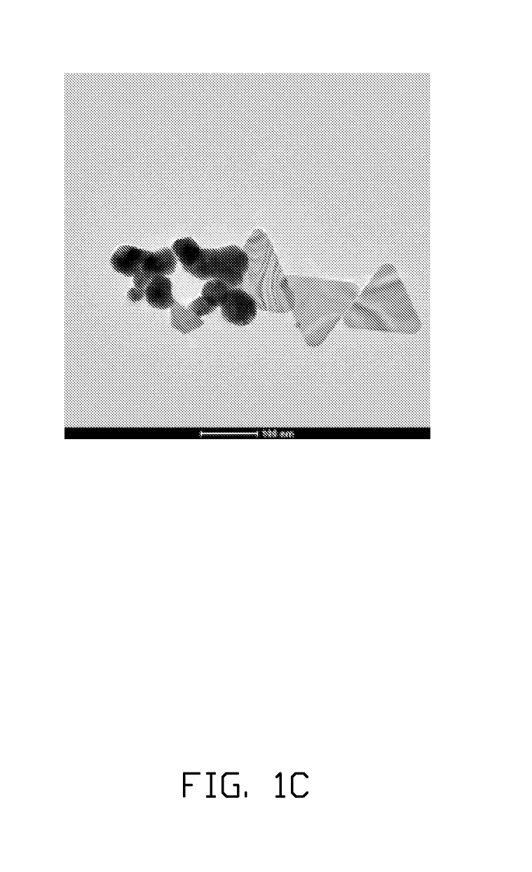

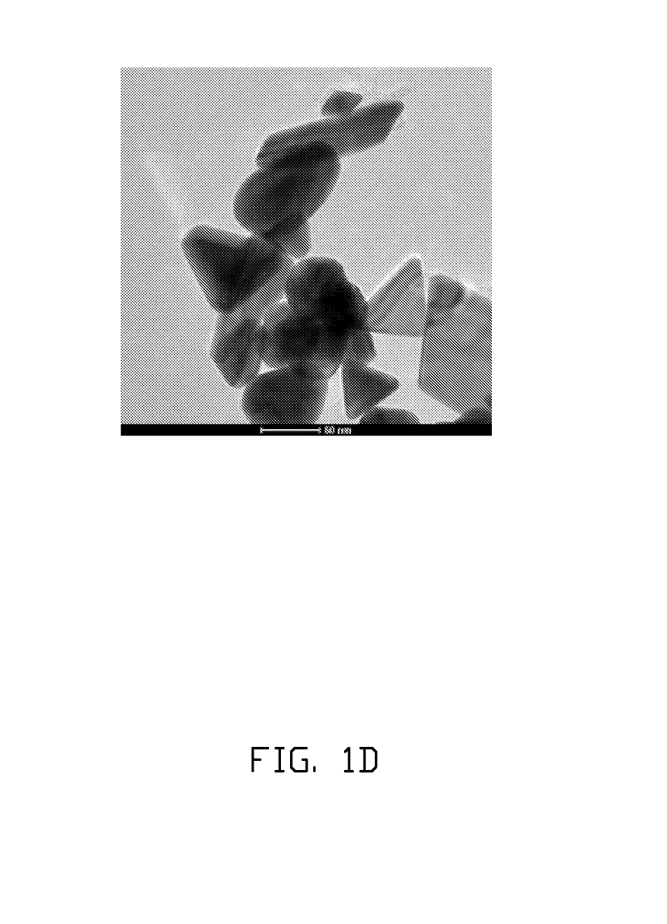

A reacting container is treated by aqua regia, washed several times by distilled water, and then heated by a water bath at about 50° C. The HAuCl₄ water solution and C₆H₈O₇ are mixed in the reacting container, in a molar ratio of about 1:1 for HAuCl₄:C₆H₈O₇, to form the mixture. The pH value of the mixture is adjusted to about 3 by adding hydrochloric acid to the mixture. The mixture is stirred to promote the reaction between HAuCl₄ and C₆H₈O₇ and samples of the achieved gold nanoparticle colloidal solution is taken from the mixture at different sampling times (i.e., the reaction time, T). The sampling time and pH value for the samples are shown in the Table 1. The sampling times are calculated from the beginning of the mixing between HAuCl₄ and C₆H₈O₇. The samples are cooled by immersing in about 4° C. cold water to stop the reaction, and then standing for 2 days before taking the TEM photos shown in FIGS. 1A-1D.

Referring to FIGS. 1A-1D, the gold nanoplates with relatively light color have been formed. The overlapped nanoplates can be observed. Therefore, the thickness of the gold nanoplates is relatively small. Referring to FIG. 1A, when T is about 30 minutes, triangular gold nanoplates are formed with a side length of about 20 nanometers to about 40 nanometers. Rectangular gold nanoplates and a plurality of aggregated gold nanograins are also formed accompanying the triangular gold nanoplates. Referring to FIG. 1B, when T is about 45 minutes, some triangular gold nanoplates are self-assembled to form the truncated triangular gold nanoplates and hexagon gold nanoplates with a side length of about 50 nanometers to about 100 nanometers. Referring to FIG. 1C, when T is about 150 minutes, the amount of truncated triangular gold nanoplates and hexagon gold nanoplates decreased, and a plurality of triangular gold nanoplates with a side length of about 60 nanometers to about 80 nanometers are formed. Referring to FIG. 1D, when T is about 330 minutes, the amount of the triangular gold nanoplates decreased, and pentahedron and hexahedron gold nanoparticles with a side length of about 30 nanometers to about 55 nanometers are formed.

### Example 2

### Synthesis of the Gold Nanonetworks

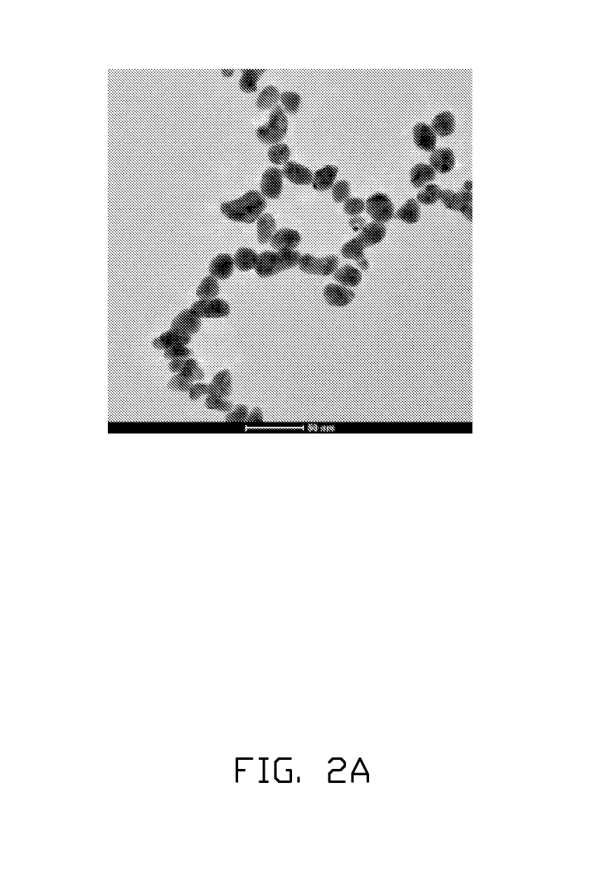

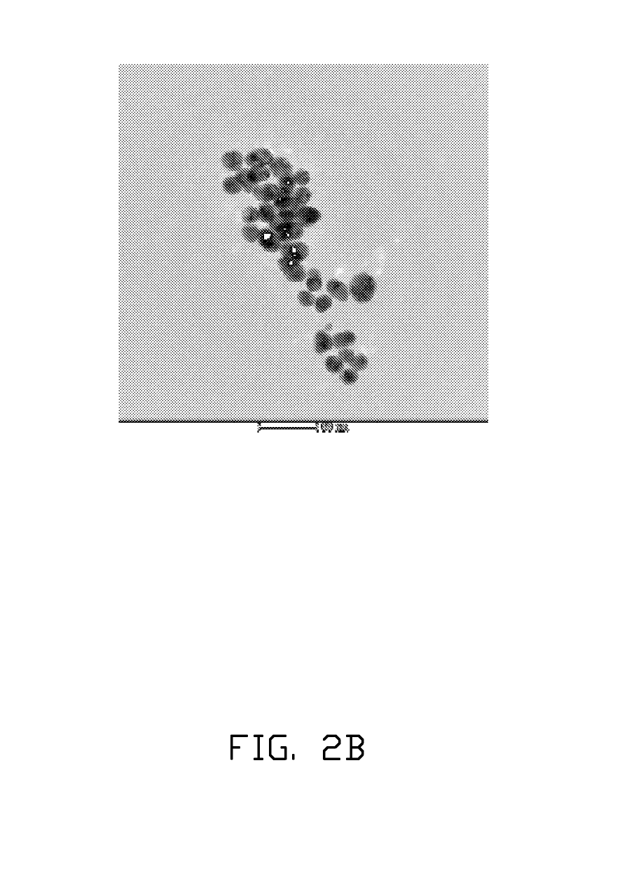

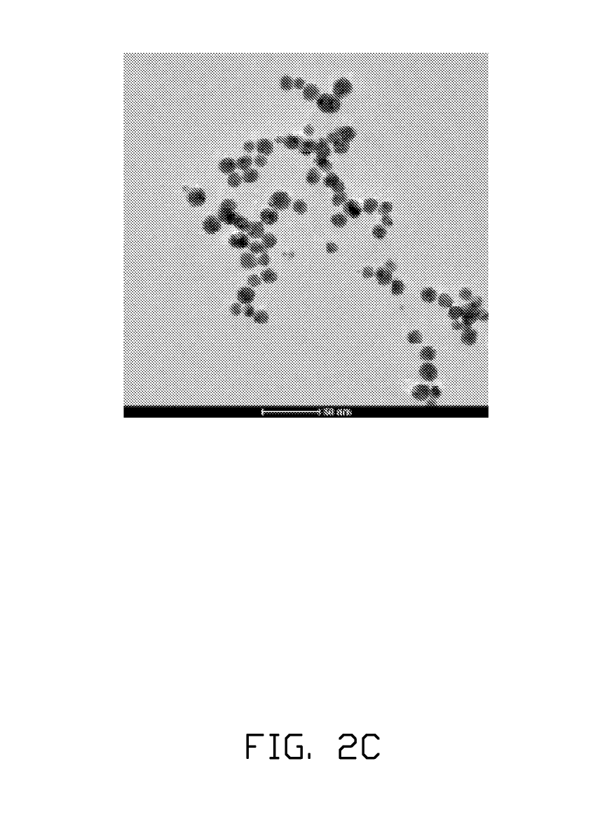

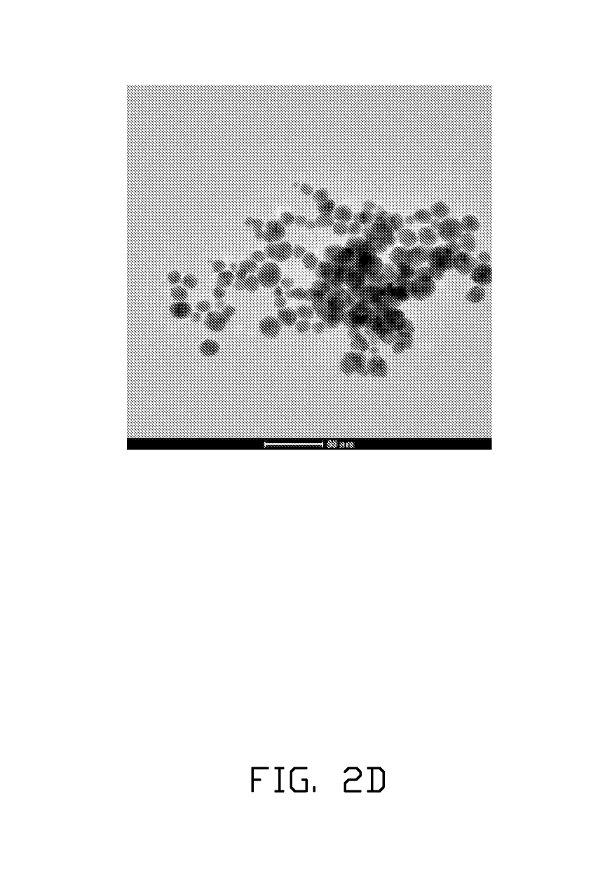

In this example, the gold nanonetworks are synthesized by the same method as in Example 1, except for the pH value of the mixture and the reaction time. In this example, the pH is about 5, and T is about 3 minutes and about 24 hours. TEM photos are shown in FIGS. 2A-2B.

Referring to FIG. 2A, at the beginning of the reaction when T is about 3 minutes and pH is about 5, gold nanonetworks can be observed. As the reaction time increases, aggregations occurred among the gold nanonetworks. Referring to FIG. 2B, when T is about 24 hours and pH is about 5, the diameter of the gold nanograins in the gold nanonetworks decreased and the gold nanonetworks compacted. The diameter of the gold nanograins in the gold nanonetworks is in a range from about 10 nanometers to about 18 nanometers.

### Example 3

### Synthesis of the Gold Nanonetworks

In this example, the gold nanonetworks are synthesized by the same method as in Example 1, except for the pH value of the mixture and the reaction time. In this example, pH is about 7, and T is about 450 min and about 24 hours. TEM photos are shown in FIGS. 2C-2D.

Referring to FIG. 2C, when T is about 450 min and pH is about 7 the synthesized gold nanonetworks are loosely accompanied with some gold nanochains. Referring to FIG. 2D, when T is about 24 hours and pH is about 7 the gold nanonetworks self-assembled to be relatively compacted.

### Example 4

### Synthesis of the Gold Nanochains

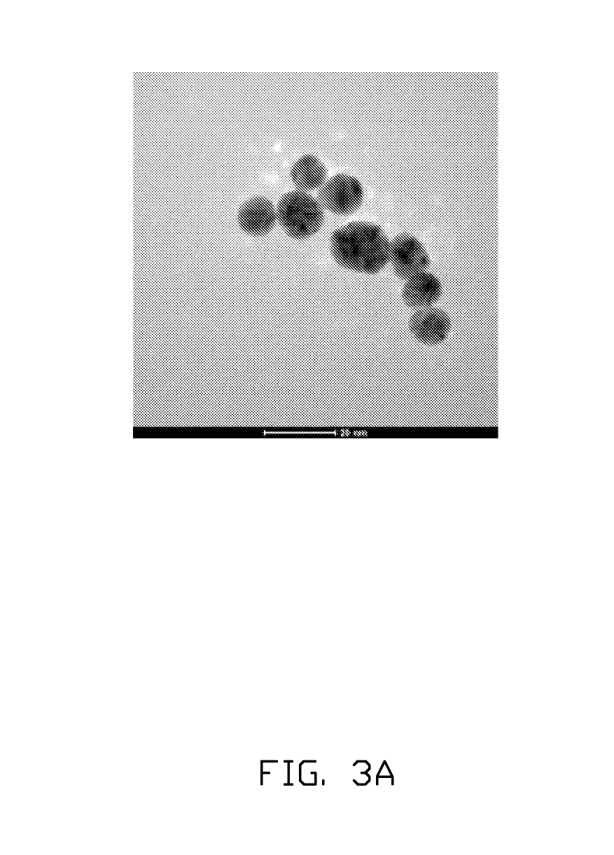

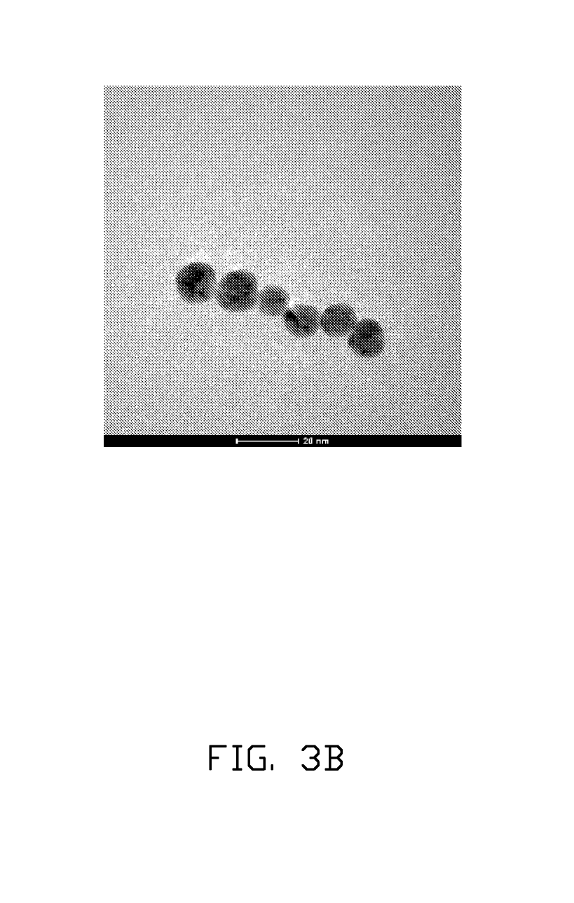

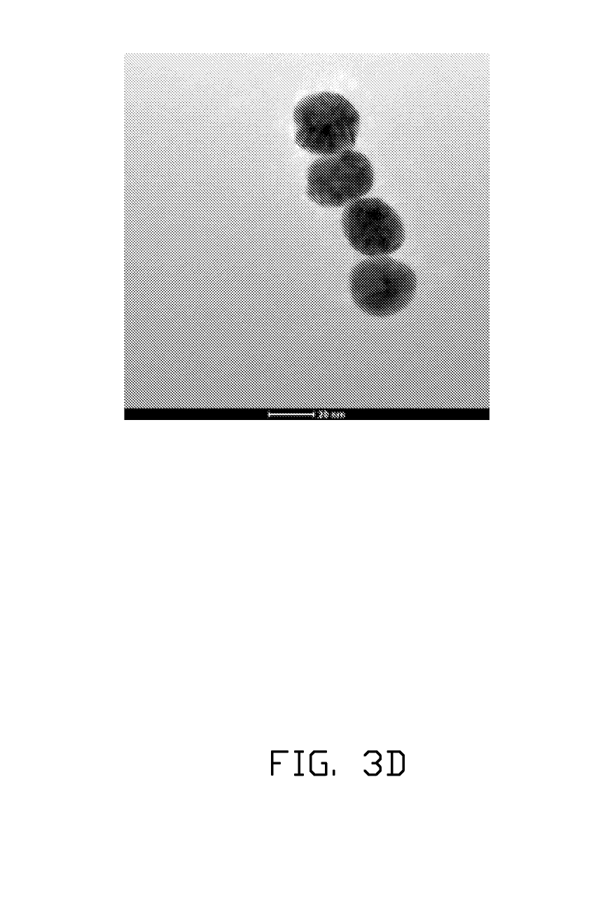

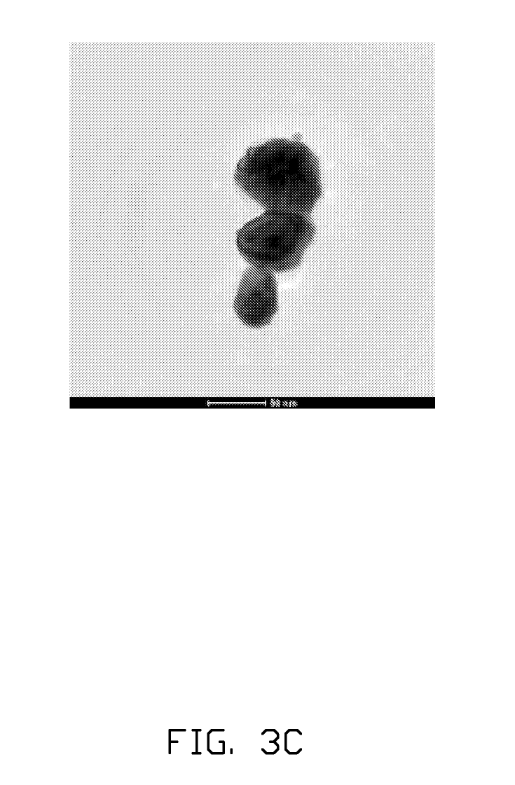

In this example, the gold nanochains are synthesized by the same method as in Example 1, except for the pH value of the mixture and the reaction time. In this example, the pH value is adjusted by adding sodium hydroxide to the mixture and pH is about 9. T is about 90 min and about 450 min. The TEM photos are shown in FIGS. 3A-3B.

Referring to FIG. 3A-3B, the gold nanochains include a plurality of gold nanograins closely joined one by one to form a line. The diameter of the gold nanograins is in a range from about 10 nanometers to about 55 nanometers.

### Example 5

### Synthesis of the Gold Nanochains

In this example, the gold nanochains are synthesized by the same method as in Example 1, except for the pH value of the mixture and the reaction time. In this example, the pH value is adjusted by adding sodium hydroxide to the mixture, and pH is about 11. T is about 15 min and about 450 min. The TEM photos are shown in FIG. 3C-3D.

In addition, substantially no gold particles are formed by reacting the HAuCl₄ water solution with C₆H₈O₇ at 50° C. for about 24 hours, at pH of about 1 and about 13.

TABLE 1

| Example | T | | pH value |
|---|---|---|---|
| FIG. 1A | 30 | minutes | 3 |
| FIG. 1B | 45 | minutes | 3 |
| FIG. 1C | 150 | minutes | 3 |
| FIG. 1D | 330 | minutes | 3 |
| FIG. 2A | 3 | minutes | 5 |
| FIG. 2B | 24 | hours | 5 |
| FIG. 2C | 450 | minutes | 7 |
| FIG. 2D | 24 | hours | 7 |
| FIG. 3A | 90 | minutes | 9 |
| FIG. 3B | 450 | minutes | 9 |
| FIG. 3C | 15 | minutes | 11 |
| FIG. 3D | 24 | hours | 11 |

Depending on the embodiment, certain steps of methods described may be removed, others may be added, and the sequence of steps may be altered. It is also to be understood that the description and the claims drawn to a method may include some indication in reference to certain steps. However, the indication used is only to be viewed for identification purposes and not as a suggestion as to an order for the steps.

Finally, it is to be understood that the above-described embodiments are intended to illustrate rather than limit the present disclosure. Variations may be made to the embodiments without departing from the spirit of the present disclosure as claimed. Elements associated with any of the above embodiments are envisioned to be associated with any other embodiments. The above-described embodiments illustrate the scope of the present disclosure but do not restrict the scope of the present disclosure.

What is claimed is:

1. A method for synthesizing gold nanoparticles, the method comprising:
providing a gold ion containing solution and a carboxylic acid comprising at least two carboxyl groups;
mixing the gold ion containing solution and the carboxylic acid to form a mixture; and
reacting the mixture at a reaction temperature of about 20° C. to about 60° C. to achieve a gold nanoparticle colloidal solution.

2. The method of claim 1, wherein the gold ion containing solution comprises a solvent and a gold source dissolved in the solvent.

3. The method of claim 1, wherein the gold source is selected from the group consisting of chloroauric acid, gold trichloride, gold potassium chloride, and combinations thereof.

4. The method of claim 1, wherein the carboxylic acid is selected from the group consisting of citric acid, oxalic acid, malonic acid, butane diacid, and combinations thereof.

5. The method of claim 1, wherein a molar ratio of gold ions in the gold ion containing solution to the carboxylic acid is in a range from about 10:1 to about 1:10.

6. The method of claim 1, wherein the reaction temperature is in a range from about 30° C. to about 50° C.

7. The method of claim 1, wherein the gold nanoparticle colloidal solution comprises at least one of gold nanoplates, gold nanonetworks, gold nanochains, and monodispersed gold nanograins.

8. The method of claim 7, wherein the gold nanonetworks and the nanochains each comprises a plurality of gold nanograins connected with each other by carboxyl groups.

9. The method of claim 1, further comprising adjusting a pH value of the mixture to control a morphology of the gold nanoparticles.

10. The method of claim 1, further comprising adjusting a pH value of the mixture to about 2-4.4 to form gold nanoplates.

11. The method of claim 1, further comprising a step of adjusting a pH value of the mixture to about 4.5-7.8 to form gold nanonetworks.

12. The method of claim 1, further comprising a step of adjusting a pH value of the mixture to about 7.9-12.7 to form gold nanochains.

13. The method of claim 1, further comprising a step of adding a supplemental reducing agent to the mixture to form monodispersed gold nanograins.

14. The method of claim 13, wherein a molar ratio of the supplemental reducing agent to gold ions in the mixture is in a range from about 3:1 to about 7:1.

15. The method of claim 13, wherein the supplemental reducing agent is selected from the group consisting of sodium borohydride, formaldehyde, ascorbic acid, and combinations thereof.

16. A method for synthesizing gold nanoparticles, the method comprising:
providing a gold ion containing solution and a carboxylic acid comprising at least two carboxyl groups;
mixing the gold ion containing solution and the carboxylic acid to form a mixture; and
reacting the mixture at a reaction temperature of about 20° C. to about 60° C. to reduce and stabilize the gold ion containing solution only by the carboxylic acid.

17. A method for synthesizing gold nanoparticles, the method comprising:
providing a gold ion solution and a carboxylic acid acting as a reducing agent and a stabilizing agent, wherein the carboxylic acid comprises at least two carboxyl groups; and
mixing and reacting the gold ions containing solution and the carboxylic acid at a reaction temperature in a range from about 20° C. to about 60° C.

18. The method of claim 17, wherein the reaction temperature is in a range from about 30° C. to about 50° C.
